(19) United States
(12) Patent Application Publication
(10) Pub. No.: US 2004/0011601 A1
(43) Pub. Date: Jan. 22, 2004

(54) Implement for driving a tool and including a brake for braking the tool

(76) Inventors: Helmut Jakobs, Huckeswagen (DE); Manfred Schlasse, Hagen (DE); Horst Radix, Schwerte (DE)

Correspondence Address: THOMAS, KAYDEN, HORSTEMEYER & RISLEY, LLP, 100 GALLERIA PARKWAY, NW, STE 1750, ATLANTA, GA, 30339-5948, US

(21) Appl. No.: 10/402,884

(22) Filed: Mar. 28, 2003

(30) Foreign Application Priority Data
Mar. 30, 2002 (DE) 102 14 419.2-23

(51) Int. Cl. F16D 55/36

(52) U.S. Cl. 188/71.5; 188/72.1

(57) ABSTRACT

An implement includes a driving shaft (1) and a driven shaft (2) to be operatively connected to the driving shaft (1). A tool—for example for mowing, cutting or grinding—is designed and arranged to be connected to the driven shaft (2) to be driven by the driven shaft (2) and by a motor driving the driving shaft (1). A brake (6) includes a first element (8) and a second element (7). The second element (7) engages the driven shaft (2), and it is movable in an axial direction. A unit alternately connects and disconnects the driving shaft (1) and the driven shaft (2). The unit includes a stop (12) and a counter stop (13) transmitting torque. The unit also includes an inclined plane (10) serving to produce an axial movement of the second element (7) of the brake (6) with respect to the first element (8) of the brake (6) for automatic actuation of the brake (6). With the novel implement, the desired braking effect is automatically achieved when the drive is switched off.

### CROSS REFERENCE TO RELATED APPLICATIONS

This application claims priority to co-pending German Patent Application No. 102 14 419.2 entitled “Arbeitsgerät mit mindestens einem über einen Motor antreibbaren Werkzeug und einer das Werkzeug stillsetzenden Bremse”, filed Mar. 30, 2002.

### FIELD OF THE INVENTION

The present invention generally relates to implements and apparatuses for driving at least one tool by a motor.

For safety reasons, driven tools being part of implements have to be braked or stopped within a limited period of time after having switched off the drive. This especially applies to tools rotating at great velocities. Examples for such tools are rotational mowers, flail mowers, lawn mowers, rotary hoes, cutting wheels and grinding wheels. However, the present invention is also directed to implements or apparatuses including tools not being driven to rotate, but for example, to reciprocate. One example of the necessity of quickly initiating a braking operation for safety reasons is when the operator of a grass mower loses hand contact to the respective control elements of the implement.

### BACKGROUND OF THE INVENTION

It is generally known in the art to use a so called “dead man's button” or a “dead man's arrangement” for switching off a drive. After-running effects of the implement being connected to the drive after having switched off the drive is limited by a brake becoming active when control elements of the implement are released.

An implement in the form of a high grass mower is generally known in the art. The known implement includes a frame which may be moved by wheels. The tool being part of the implement is designed as a rotatable mowing disk including mowing elements. The known implement includes a motor from which a drive leads to the tool. The drive includes a driving shaft being connected to the motor and a driven shaft being connected to the tool. The two axes of the shafts are located next to one another on the frame to be parallel. The driving shaft and the driven shaft each includes a pulley to be contacted by a driving belt. The driving belt is held in its tensioned position by a stretching roller when torque of the motor is to be transmitted to the tool. The known implement also includes a brake including two elements of which one element is supported at the frame of the implement, and the other element of the brake is arranged to engage the driven shaft being connected to the tool. One element of the brake is formed by a braking band being supported at the frame and surrounding a brake drum, and the other element of the brake is designed as the brake drum being connected to the driven shaft. One end of the braking band is supported in a fixed location at the frame, and the other end is supported at a lever carrying the tension roll. A tension spring engages the lever in the engaging direction of the brake and in the disengaging direction of the tension roll. In this way, one achieves a unit for connecting and disconnecting the driving shaft and the driven shaft. There is a Bowden pull wire to be actuated by a hand lever. When manually pulling this hand lever, the brake is released against the force of the tension spring, and the tension roll is engaged such that torque may be transmitted from the motor to the tool. When manually releasing the hand lever, the brake is actuated due to the force of the tension spring, and the tension roll is disengaged such that no more torque is transmitted from the motor to the tool. In this way, the braking effect directly depends on the position of the hand lever.

A mowing apparatus is known from U.S. Pat. No. 4,696,150. The known mowing apparatus includes a combustion engine being located on a movable frame. The combustion engine drives a driving shaft. A centrifugal clutch serves to transmit the driving torque to a driven shaft on which a cutting arm including two cutters is located. The cutting arm forms the tool. The known mowing apparatus also includes a brake including two elements and effecting the tool. One element of the brake includes one or more V-belts being fixedly connected to a pivotable lever. The other element of the brake is formed by a brake drum being connected to the shaft. The V-belts surround the brake drum. A spring and a manually operable Bowden pull wire are connected to the lever. The force of the spring effects tensioning of the V-belts and, consequently, initiation of a braking effect acting upon the brake drum, the motor and the tool. The brake may be released by manually operating the Bowden pull wire by the lever against the force of the spring. In this way, the braking effect directly depends on the position of the hand lever.

In known implements using different replaceable tools, as for example, a flail mowing attachment, a lawn mowing attachment, a rotary hoe and the like, there is the disadvantage of the implement having to be supplied with different control systems depending on the used tool. These control systems have to be installed at the operation side of the implement during each tool change. Such installation is complicated, and it has a negative influence on safety properties.

### SUMMARY OF THE INVENTION

The present invention relates to an implement and an apparatus for driving a tool. The implement or the apparatus includes a driving shaft and a driven shaft being designed and arranged to be operatively connected to the driving shaft to be driven by the driving shaft. A tool is designed and arranged to be connected to the driven shaft to be driven by the driven shaft. A brake includes a first element and a second element. The second element is designed and arranged to engage the driven shaft and to be movable in an axial direction. A unit is designed and arranged to connect and to disconnect the driving shaft and the driven shaft. The unit includes a stop and a counter stop being designed and arranged to transmit torque and an inclined plane being designed and arranged to produce an axial movement of the second element of the brake with respect to the first element of the brake for automatic actuation of the brake.

With the novel implement, apparatus or device, the desired braking effect is automatically achieved when the drive is switched off. This means that the braking effect does not depend on any control commands by the operator of the implement. Braking operation is always automatically initiated when there is no driving torque and when the remaining torque is less than the torque of the after-running tool, respectively. Additionally, torque resulting when the motor is switched on is used to release the brake and to keep the brake in the released position. When the drive provides torque, the brake will be automatically released. When torque supplied by the drive decreases or totally diminishes, braking operation is automatically initiated at least with respect to the driven shaft carrying the tool.

In a more constructive embodiment of the novel implement, the drive—meaning the combination of elements such as shafts, gear wheels and the like serving to transmit torque from a motor to a tool—is not designed as a fixed connection, but rather to include a driving shaft being separate from a driven shaft. The brake including the at least two elements is located in this region. The first elements or part of the brake is supported at the frame of the implement in a stationary way, and the second element or part of the brake engages the driven shaft being connected to the tool in a way to be displaceable in an axial direction to allow for a movement along an axial path. The driving shaft and/or the driven shaft may be designed and arranged to be movable in an axial direction.

The novel implement includes an inclined plane serving for connecting and separating, respectively, the driving shaft and the driven shaft. The inclined plane in combination with a cam, a roller and the like being located at the other element allow for free motion within a certain axial path. This axial path is used to automatically engage and disengage, respectively, the brake. The design of the inclined plane may vary. The inclined plane may in fact be designed as a plain surface or rather as a bent inclined surface cooperating with another element being located at the respective other element at the inclined plane. The inclined plane may also be designed in the form of a steep thread, an inclined ramp and the like.

An energy storing unit is associated with the brake. The unit supplies force acting in the direction of engagement of the brake, meaning to automatically attain the braking effect. The energy storing unit may include a spring arrangement. The axial path of movement being supplied by the inclined plane serves to release the brake in the other direction.

In addition to the inclined plane, there is a stop and a counter stop operatively counteracting one another when the brake is released. This means that the stop and the counter stop contact one another to transmit torque to the respective tool when the motor is switched on.

One element of the brake engages the frame of the implement. Such an element may be designed as a number of stationary brake elements to operatively contact a brake disk in a way to consume energy and to slow down the tool. The frame of the implement may also be designed as a machine structure on which the other elements, especially the motor and the tool, are arranged.

The brake includes an energy storing unit being designed and arranged to span die axial path being produced by the inclined plane and to engage the brake when there is no driving torque. The energy storing unit is a device supplying a force being directed in the engaging direction of the brake such that braking operation is automatically initiated due to the force of the energy storing unit. There is a number of possibilities of realizing the energy storing unit. One possibility is to arrange pressure springs which are stressed about an axial path and which release their force when the axial path of the free motion of the elements of the brake disappears such that the brake fulfills the braking action. The energy storing unit may also include elastically deformable elements, especially plastic elements. Another exemplary possibility is to use a pneumatic or a hydraulic unit.

The first element of the brake may be designed as a brake disk protruding in a radial direction with respect to the driving shaft or to the driven shaft. The brake disk in its engaged position cooperates with brake elements being located at the frame of the implement, the brake elements forming the second element of the brake. In this case, at least one brake disk has to be used. However, it is also possible to use a plurality of brake disks, as it is for example the case in multiple brake disks. The brake elements may be designed as frictional elements. They may be arranged in a stationary way.

The brake may be arranged on the driven shaft. Such an arrangement ensures that the after-running tool is braked within a comparatively short period of time. It is also possible to arrange a clutch in the drive in addition to the brake such that the brake only has to decelerate the moment of inertia of the tool, whereas the motor does not have to be decelerated by the brake. In this way, the moment of inertia at the side of the drive to be decelerated by the brake is decreased, and the tool may be decelerated even more quickly.

It is preferred if the brake includes the inclined plane and the counter stop, while the stop is located on the driving shaft. In this way, there is the possibility of arranging the driving shaft and the driven shaft in a stationary way, meaning in a way not to be displaceable in an axial direction. In this case, the brake and an element of the brake, respectively, includes the inclined plane and the counter stop fulfilling the axial movement. The respective element of the brake is arranged on the driven shaft to be movable in an axial direction but not to be rotated with respect to the driven shaft. For example, this movement may be realized by a groove channel tooth arrangement.

It is preferred when the counter stop is located at one end of the inclined plane. In this way, it is ensured that the counter stop is reached after having passed through the inclined plane. The stop then contacts the counter stop. In this way, torque may be transmitted.

No matter at which element the inclined plane is located, there always is the possibility of designing the inclined plane to have an angle of inclination of approximately between 4° to 12°. It is to be understood that the angle of inclination is chosen depending on the desired intensity of the braking effect. For this purpose, frictional conditions acting between the cam and the inclined plane are taken into account. Friction may be decreased by using a rotatable roller, a cam having a rounded design and the like.

For example, the brake may be designed as a disk brake, a taper brake or a multiple disk brake. However, all known types of brakes to be engaged and disengaged by moving within a certain free path may be used.

It may make sense to use a second stop and a second counter stop to limit the free motion of the relative rotational movement between the driving shaft and the driven shaft. The second stop and the second counter stop are not necessarily required. When including them in the novel implement, it is ensured that the driving shaft and the driven shaft may only rotate with respect to one another to a limited extent. This also applies to the sense of rotation in which no torque is transmitted. In this way, vibrations occurring between the driving shaft and the driven shaft during braking action are counteracted. It is ensured that the free motion of the relative rotational movement only takes place between the two pairs of stops between which the inclined plane is arranged.

There also is a number of possibilities of designing the counter element or the inclined plane. For example, a cam, a roller and the like may be associated with the inclined plane. A rounded shape of the cam may serve to reduce friction and to realize the axial movement in a more sensitive way.

Other features and advantages of the present invention will become apparent to one with skill in the art upon examination of the following drawings and the detailed description. It is intended that all such additional features and advantages be included herein within the scope of the present invention, as defined by the claims.

### BRIEF DESCRIPTION OF THE DRAWINGS

The invention can be better understood with reference to the following drawings. The components in the drawings are not necessarily to scale, emphasis instead being placed upon clearly illustrating the principles of the present invention. In the drawings, like reference numerals designate corresponding parts throughout the several views.

FIG. 1 is a schematic side view illustrating some elements of the novel implement in the position when torque is transmitted in the drive.

FIG. 2 is a sectional view along line II-II in FIG. 1.

FIG. 3 is a schematic side view of the elements of FIG. 1 in the braking position.

FIG. 4 is a sectional view along line IV-IV in FIG. 3.

FIG. 5 is a side view of some elements of a second exemplary embodiment of the novel implement including an inclined plane being formed by a thread-like ramp in a position in which torque is transmitted.

FIG. 6 is a sectional view along line VI-VI in FIG. 5.

FIG. 7 is a view of the elements of FIG. 5 in the braking position.

FIG. 8 is a view along line VIII-VIII in FIG. 7.

FIG. 9 is a schematic side view of some elements of another exemplary embodiment of the novel implement in a position in which torque is transmitted.

FIG. 10 is a sectional view along line X-X in FIG. 9.

FIG. 11 is a schematic side view of the elements of FIG. 9 in the braking position.

FIG. 12 is a sectional view along line XII-XII in FIG. 11.

FIG. 13 is a view of an exemplary embodiment of the brake being designed as a disk brake in a position in which the brake is released.

FIG. 14 is a view of the brake according to FIG. 13 in the braking position.

FIG. 15 is a view of the brake being designed as a multiple disk brake.

FIG. 16 is a view of the exemplary embodiment of the brake according to FIG. 15 in the braking position.

### DETAILED DESCRIPTION

Referring now in greater detail to the drawings, FIG. 1 schematically illustrates some elements of the novel implement or apparatus. FIG. 1 especially illustrates the place where a driving shaft 1 and a driven shaft 2 are connected and interconnected, respectively. The shafts 1 and 2 are arranged in an aligned way to have a common axis 3. One may assume that the driving shaft 1 is rotated in the direction of arrow 4 such that the driven shaft 2 is rotated in the same direction according to arrow 5.

A brake 6 is located on the driven shaft 2. The brake 6 is fixedly connected to the driven shaft 2 such that the driven shaft 2 and the brake 6 are commonly rotated. The unit being formed by the driven shaft 2 and the brake 6 is designed and arranged to be movable in the direction of the axis 3, as it may be seen from a comparison of FIGS. 1 and 3. The driving shaft 1 is not moved in such an axial direction. The brake 6 includes a brake disk 7 being designed and arranged to cooperate with a brake element 8 (see FIGS. 1 and 3). The brake element 8 is only illustrated in a schematic way. In a more constructive exemplary embodiment, a number of braking elements 8 is uniformly distributed about the circumference. The braking element 8 and the braking elements 8, respectively, are supported at a frame 9 in a stationary way. The frame 9 may also be the stand of the implement, or it may be connected thereto.

It is to be understood that the driving shaft 1 is associated with a driving unit. The driving unit may include a motor or an engine, especially an electric motor. However, the driving unit is not illustrated since it may have a design well known in the art. The driven shaft 2 is associated with a driven unit. The driven unit includes a tool of the implement also not being illustrated since it may have a design well known in the art.

The brake 6 includes an inclined plane 10. A cam 11 being located at the side of the driving shaft 1 is associated with the inclined plane 10. During relative rotational movement of the driving shaft 1 with respect to the driven shaft 2, the cam 11 slides on the inclined plane 10 depending on the direction of rotation of the driving shaft 1, and it moves the unit including the driven shaft 2 and the brake 6 in the direction of the axis 3. This movement takes place within a certain axial path being produced by the inclination of the inclined plane 10 in the axial direction. This axial path is at least identical to, but preferably more than the axial space being required between the brake disk 7 and the brake elements 8 for effectively disengaging and engaging, respectively, the brake 6.

A first stop 12 is located at the cam 11 in the driving sense of rotation according to arrows 4 and 5. A counter stop 13 is located at the brake 6, the counter stop 13 being associated with the stop 12. Preferably, the counter stop 13 may be located at the end of the inclined plane 10.

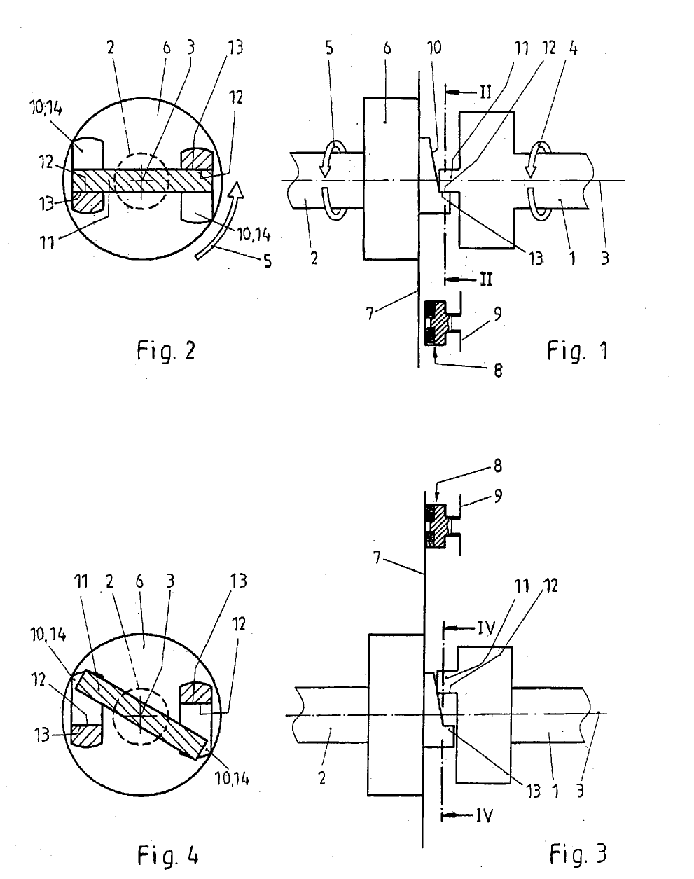

It is to be seen from FIG. 2 that the inclined plane 10 is located at the brake 6 and at a part thereof, respectively, in a double arrangement as two inclined ramps 14. The cam 11 at the driving shaft 1 extends along a diameter in a continuous way such that the stop 12 is also designed in a double arrangement. The inclined ramps 14 correspondingly end in two counter stops 13.

When the motor is switched off and the tool is not operated, the elements of the implement are located in the braking position as illustrated in FIGS. 3 and 4. As soon as the motor is switched on, the driving shaft 1 will start to rotate in the direction of arrow 4, while the driven shaft 2 does not yet rotate. Consequently, the cam 11 contacting the inclined plane 10 will be moved and dislocated on the inclined plane 10 until it reaches the position illustrated in FIGS. 1 and 2. In this way, the unit including the driven shaft 2 and the brake 6 will be moved in the direction of the axis 3 and away from to the driving shaft 1. The brake 6 will be disengaged and released, respectively. During the last portion of this movement, the stop 12 contacts the counter stop 13 such that the driven shaft 2 is rotated with the same number of rotations and commonly with the driving shaft 1. As a result, there is the position as it is to be seen in FIGS. 1 and 2. In this position, torque is being transmitted, the torque being used for operating the tool of the novel implement.

To terminate operation of the tool, the motor is turned off. This may be achieved by a so called “dead man's button” or a “dead man's arrangement”. Due to and following the switching off process, torque at the side of the drive will decrease and diminish, and later on no torque will be supplied such that the driving shaft 1 rotates at a lower number of rotations than the driven shaft 2 being operatively connected to the tool. Consequently, there will be an axial movement in the opposite direction as described hereinabove. The cam 11 moves back along the inclined plane 10 until the position of FIGS. 3 and 4 has been reached. In this way, the brake 6 is simultaneously engaged. Engagement is realized by the braking disk 7 contacting the braking elements 8. Due to this braking action, the rotational movement of the driven shaft 2 is also terminated.

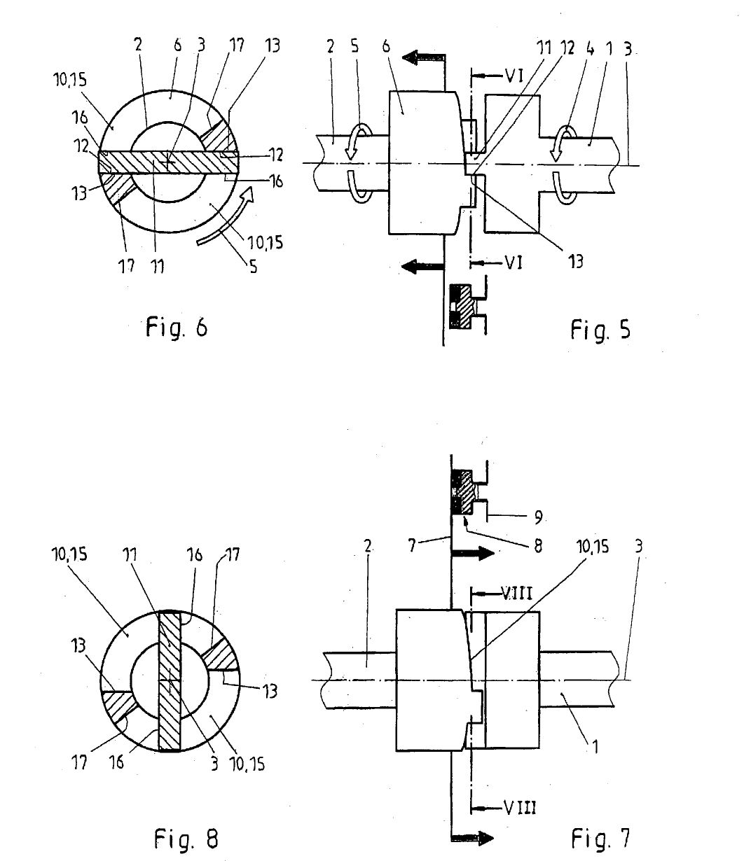

FIGS. 5 to 8 illustrate a second exemplary embodiment of the novel implement. In this case, the inclined plane 10 is not designed as a plain surface, but rather as a thread-like ramp 15 having a double design shape. In this exemplary embodiment, there is another pair of stops being located in the other sense of rotation, meaning a second stop 16 being located at the cam 11 and an associated counter stop 17 being located at the brake 6. These stops are designed to have a double arrangement.

With respect to the functionality of the novel implement, it is now referred to the exemplary embodiment illustrated in FIGS. 1 to 4. Due to the additional arrangement of two stops 16 and two counter stops 17, it is ensured that the relative free motion between the driving shaft 1 and the driven shaft 2 is limited to an extent being defined by the angle between the two stops. The inclined plane 10 is located in this intermediate portion. In this way, it is ensured that undesired relative movement occurring between the elements with respect to one another is limited even when vibrations, shocks and the like occur in the opposite direction. Thus, the elements can only rotate with respect to one another within a limited portion of free motion. The inclined plane 10 becomes effective depending on the rotational position.

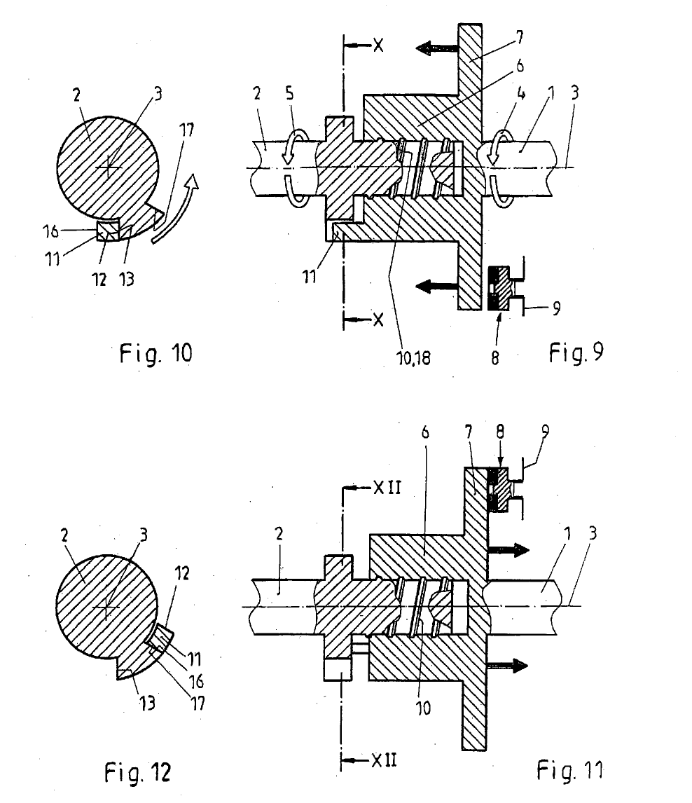

FIGS. 9 to 12 illustrate another exemplary embodiment of the novel implement. It is to be seen from these figures that the brake 6 is arranged at the side of the driving shaft 1. Consequently, the unit including the driving shaft 1 and the brake 6 is supported to be movable in an axial direction. The inclined plane 10 is designed as a thread 18. This exemplary embodiment may be realized with or without a second stop 16 and a second counter stop 17.

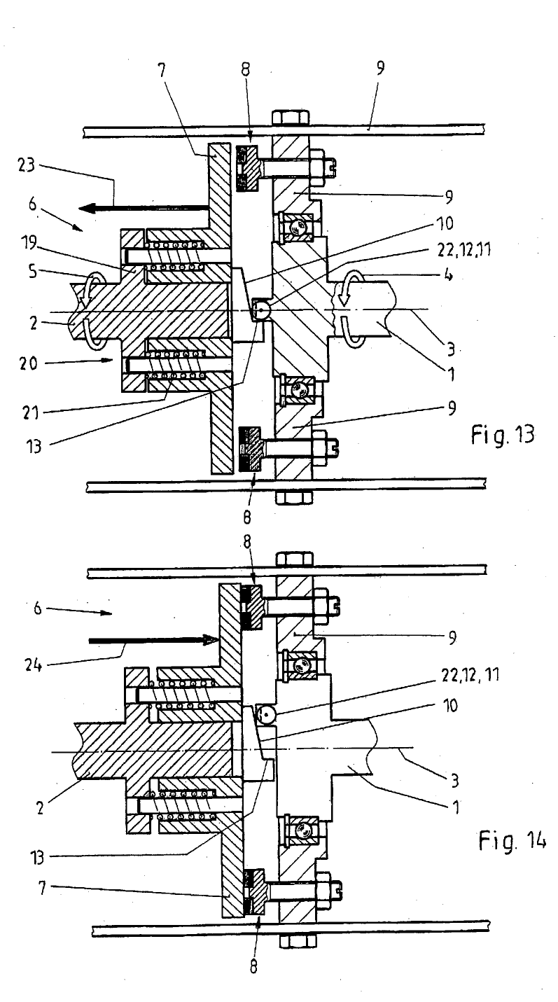

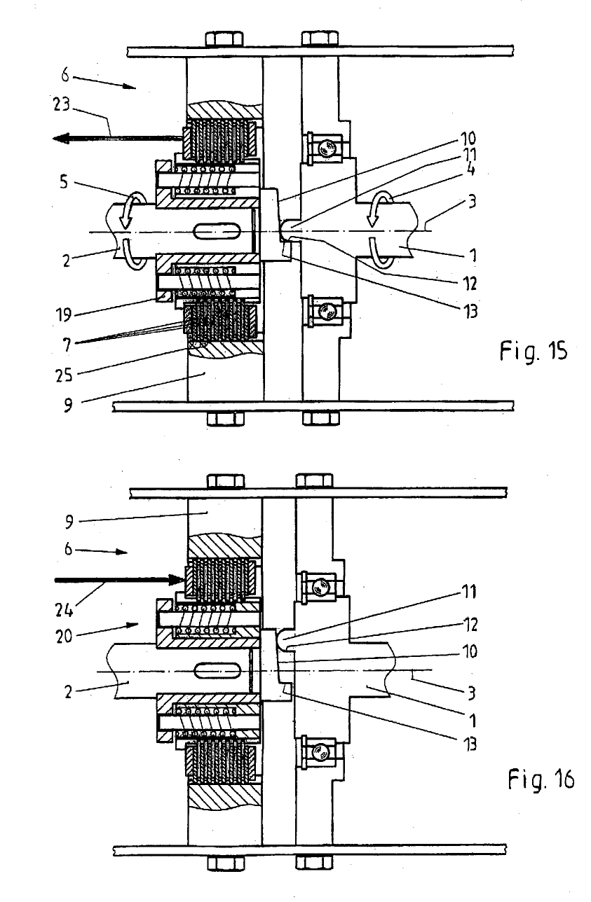

FIGS. 13 and 14 illustrate the brake 6 in a more constructive way and as being designed as a disk brake. The brake 6 includes a housing 19 and a brake disk 7. The housing 19 is fixedly connected to the driven shaft 2 such that it cannot be rotated and it cannot be moved in an axial direction. The inclined plane 10 is located on the brake disk 7, and the inclined plane 10 and the brake disk 7 may be commonly moved in an axial direction according to the axis 3. An energy storing unit 20 including a plurality of pressure springs 21 is located between the housing 19 and the brake disk 7. The unit 20 tends to push the brake disk 7 towards the brake elements 8 being located at the frame 9. In this embodiment, the cam 11 is designed as a roller 22 being connected to the driving shaft 1 and at an enlarged portion thereof, respectively. The enlarged portion thereof, respectively. The enlarged portion also serves to support the driving shaft 1 with the illustrated ball bearings in the region of the frame 9. The roll 22 also serves to fulfill the function of the first stop 12.

It is to be seen in FIG. 13 that the brake 6 has been released. Torque is transmitted from the driving shaft 1 to the driven shaft 2. Due to the fact that the roller 22 has been sliding upon the inclined plane 10, the driving shaft 1 has moved along an axial path. Arrow 23 indicates the axial force being transmitted by the inclined plane 10 onto the brake disk 7 and compressing the pressure springs 21 of the energy storing unit 20.

FIG. 14 illustrates the braking position after the driving torque at the driving shaft 1 has disappeared. The pressure springs 21 of the energy storing unit 20 have dislocated the brake disk 7 according to arrow 24 to an extent such that the brake disk 7 contacts the brake elements 8. Consequently, the driven shaft 2 is slowed down.

The exemplary embodiment illustrated in FIGS. 15 and 16 shows the brake 6 being designed as a multiple disk brake. There is a plurality of brake disks 7 being fixedly connected to the housing 19. Another set of brake disks 25 is connected to the frame 9. Such a multiple disk brake only requires comparatively little axial room for opening and closing the brake 6. Consequently, the inclined plane 10 may have a smaller angle of inclination of approximately 4° providing less resulting axial movement than an inclined plane having a greater angle of inclination. Again, the implement includes an energy storing unit 20. The cam 11 being located at the end of the driving shaft 1 has a rounded design.

It is imaginable that at least one of the elements—meaning the driving shaft 1, the driven shaft 2 or another element of the brake 6 (the brake disk 7, for example)—is designed and arranged to be movable in an axial direction according to the axis 3 to produce the necessary axial movement for opening and closing the brake 6. This path being required for actuation of the brake 6 is supplied by an inclined plane 10 such that the brake 6 is automatically engaged or disengaged depending on the relative rotational position existing between the driving shaft 1 and the driven shaft 2.

Many variations and modifications may be made to the preferred embodiments of the invention without departing substantially from the spirit and principles of the invention. All such modifications and variations are intended to be included herein within the scope of the present invention, as defined by the following claims.

We claim:

1. An implement, comprising:
a driving shaft;
a driven shaft being designed and arranged to be operatively connected to said driving shaft to be driven by said driving shaft;
a brake including a first element and a second element, said second element being designed and arranged to engage said driven shaft and to be movable in an axial direction; and
a unit being designed and arranged to connect and to disconnect said driving shaft and said driven shaft, said unit including a stop and a counter stop being designed and arranged to transmit torque and an inclined plane being designed and arranged to produce an axial movement of said second element of said brake with respect to said first element of said brake for automatic actuation of said brake.

2. The implement of claim 1, wherein said brake further includes an energy storing unit, said energy storing unit being designed and arranged to span the path of axial movement being produced by said inclined plane and to engage said brake when said driving shaft does not supply torque.

3. The implement of claim 1, wherein said first element of said brake is designed as a plurality of brake elements and said second element of said brake is designed as at least one a brake disk, said brake elements and said brake disk being designed and arranged to contact one another in an engaging position of said brake.

4. The implement of claim 2, wherein said first element of said brake is designed as a plurality of brake elements and said second element of said brake is designed as at least one a brake disk, said brake elements and said brake disk being designed and arranged to contact one another in an engaging position of said brake.

5. The implement of claim 3, wherein said brake disk protrudes from said driven shaft in a radial direction.

6. The implement of claim 4, wherein said brake disk protrudes from said driven shaft in a radial direction.

7. The implement of claim 1, wherein said driven shaft is designed and arranged to be operatively connected to a tool to drive the tool.

8. The implement of claim 1, wherein said second element of said brake is designed and arranged to be movable with respect to said driven shaft in an axial direction.

9. The implement of claim 1, wherein said inclined plane and said counter stop are part of said brake, and wherein said stop is arranged on said driving shaft.

10. The implement of claim 8, wherein said counter stop is arranged at one end of said inclined plane.

11. The implement of claim 1, wherein said inclined plane has an angle of inclination of approximately between 4°-12°.

12. The implement of claim 1, wherein said brake is designed as a disk brake.

13. The implement of claim 1, wherein said brake is designed as a taper brake.

14. The implement of claim 1, wherein said brake is designed as a multiple disk brake.

15. The implement of claim 1, further comprising a second stop and a second counter stop being designed and arranged to limit the possible relative movement between said driving shaft and said driven shaft.

16. The implement of claim 1, further comprising a cam being associated with said inclined plane.

17. The implement of claim 1, further comprising a roll being associated with said inclined plane.

18. The implement of claim 1, further comprising at least one drive, said driving shaft and said driven shaft being part of said drive.

19. The implement of claim 17, wherein said drive is designed and arranged to be driven by a motor.

20. An apparatus for driving a tool, comprising:
a frame;
a driving shaft;
a driven shaft being designed and arranged to be operatively connected to said driving shaft to be driven by said driving shaft and being designed and arranged to be operatively connected a tool to drive the tool;
a brake including a first element and a second element,
said first element being fixedly connected to said frame,
said second element being designed and arranged to engage said driven shaft,
said second element being designed and arranged to be movable in an axial direction; and
a unit being designed and arranged to connect and to disconnect said driving shaft and said driven shaft, said unit including a stop and a counter stop being designed and arranged to transmit torque and an inclined plane being designed and arranged to produce an axial path for automatic actuation of said brake.

21. The apparatus of claim 20, wherein said brake further includes an energy storing unit, said energy storing unit being designed and arranged to span the path of axial movement being produced by said inclined plane and to engage said brake when said driving shaft does not supply torque.

22. The apparatus of claim 20, wherein said second element of said brake is designed and arranged to be movable with respect to said driven shaft in an axial direction.

23. An apparatus for driving a tool, comprising:
a frame;
a driving shaft;
a driven shaft being designed and arranged to be operatively connected to said driving shaft to be driven by said driving shaft and being designed and arranged to be operatively connected a tool to drive the tool;
a brake including a plurality of brake elements and at least one a brake disk,
said brake elements being fixedly connected to said frame,
said brake disk being connected to said driven shaft,
said brake disk being designed and arranged to be movable in an axial direction with respect to said brake elements; and
a unit being designed and arranged to connect and to disconnect said driving shaft and said driven shaft, said unit including:
a stop and a counter stop being designed and arranged to transmit torque from said driving shaft to said driven shaft and to the tool when said stop and said counter stop engage, and
an inclined plane being designed and arranged to produce an axial path for automatic actuation of said brake in a way that said brake disk and said brake elements engage and disengage depending on the torque transmitted by said driving shaft.

24. The apparatus of claim 23, wherein said brake further includes an energy storing unit, said energy storing unit being designed and arranged to span the path of axial movement being produced by said inclined plane and to engage said brake when said driving shaft does not supply torque.

25. The apparatus of claim 23, wherein said brake disk is designed and arranged to be movable with respect to said driven shaft in an axial direction.
